(19) United States
(12) Patent Application Publication
(10) Pub. No.: US 2010/0157833 A1
(43) Pub. Date: Jun. 24, 2010

(54) METHODS AND SYSTEMS FOR IMPROVED TIMING ACQUISITION FOR VARYING CHANNEL CONDITIONS

(75) Inventors: BOJAN VRCELJ, San Diego, CA (US); Krishna K. Mukkavilli, San Diego, CA (US); Raghuraman Krishnamoorthi, San Diego, CA (US); Vinay Murthy, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/644,909

(22) Filed: Dec. 22, 2009

Related U.S. Application Data
(63) Continuation-in-part of application No. 11/372,394, filed on Mar. 8, 2006.
(60) Provisional application No. 60/660,901, filed on Mar. 10, 2005.
(60) Provisional application No. 61/140,851, filed on Dec. 24, 2008.

(51) Int. Cl. H04L 12/26

(52) U.S. Cl. 370/252

(57) ABSTRACT

An improved receiver apparatus and acquisition algorithm using TDM pilots is disclosed. The timing acquisition method presented provides capabilities for adapting to changing channel conditions, in particular varying expected delay spreads. The information on an expected delay spread can be fed back to the initial acquisition algorithm based on previous successful attempts, and the delay spreads measured at that time, such as to set the length of the detection window used to in the TDM pilot processing. Based on the delay spread information, the algorithm for processing the specialized TDM pilot can adaptively modify the timing acquisition parameters for more robust performance under interference conditions. This may involve reducing the length of the detection window to just a little more than or equal to the maximum expected delay spread, which reduces sensitivity of the fine timing acquisition to signal noise.

### RELATED APPLICATIONS

This application is a continuation-in-part of U.S. patent application Ser. No. 11/372,394 entitled “Fine Timing Acquisition” filed Mar. 8, 2006, which claims the benefit of priority to U.S. Provisional Patent Application 60/660,901 filed Mar. 10, 2005, the entire contents of both of which are hereby incorporated by reference.

This application claims the benefit of priority to U.S. Provisional Patent Application Ser. No. 61/140,851 entitled “Timing Acquisition for Varying Channel Conditions,” filed on Dec. 24, 2008, the entire contents of which are hereby incorporated by reference.

### BACKGROUND

In the field of wireless communications, time acquisition using Time-Domain Multiplexed (TDM) pilot symbols is often used to acquire timing information in wireless communications systems. Known TDM pilot based timing acquisition methods, such as those relying on a time domain channel estimate, are susceptible to noise and interference. In particular, known TDM timing acquisition algorithms are susceptible to thermal noise and other sources.

### SUMMARY

The various embodiment systems, circuits and methods provide an improved receiver apparatus and acquisition algorithm using TDM pilots. To enable fine time acquisition in the presence of noise, a reduced length detection window is used to detect the TDM pilot 2 signal. The various embodiments are particularly useful in communication systems in which the TDM pilot 2 consists of two periods in the time domain, each containing 2048 samples. In this situation, channel estimates based on TDM pilot 2 may be 2048 samples long, and the corresponding sliding window or TDM2 detection window can be full size, 1024 samples long, or half-size, 512 samples long. However, the various embodiments may be scaled to any number of periods of TDM pilot 2, and to any length of those periods in time domain. Accordingly, if the TDM pilot 2 consists of time-domain periods of length N, the full-size sliding window applied on the channel estimate obtained from this pilot may be N/2 samples long, while the half-size window may be N/4 samples long. Additionally, if the estimated delay spread is shorter than one quarter of the channel estimate obtained using TDM pilot 2, namely shorter than N/4 or 512 samples and tailored to the nearest integer longer than the estimated delay spread plus some safety margin, a computationally efficient hardware structure may be implemented to minimize the hardware complexity and reduce the computational time.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a block diagram of a base station and a wireless receiver in an orthogonal frequency division multiplexing (OFDM) system according to an embodiment.

FIGS. 2A and 2B are block diagrams of a super-frame structure for the OFDM system according to an embodiment.

FIG. 3 is a diagram of a frequency-domain representation of a time division multiplexed (TDM) pilot 2 according to an embodiment.

FIG. 4 is a block diagram of a transmit (TX) data and pilot processor according to an embodiment.

FIG. 5 is a block diagram of an OFDM modulator according to an embodiment.

FIG. 6 is a diagram of a time-domain representation of a TDM pilot 2 according to an embodiment.

FIG. 7 is a diagram of the timeline of operations used for fine timing acquisition (FTA) according to an embodiment.

FIG. 8 is a block diagram of a symbol timing detector according to an embodiment.

FIG. 9A illustrates timing elements related to fining timing using pilot-2 symbols.

FIG. 9B illustrates use of a sliding detection window for identifying first and last arriving pilot symbols.

FIG. 10A is a representative plot of accumulated energy at detection window starting positions.

FIG. 10B is a representative plot of the negative derivative of the accumulated energy plot shown in FIG. 10A.

FIGS. 11A and 11B are diagrams of fine timing acquisition in 1024- and 512-window modes according to an embodiment.

FIG. 12A is a diagram of an exemplary IFT block for computing the differences d(n) and the needed modification to the original IFT block using only the 1024-window mode according to an embodiment.

FIG. 12B is a process flow diagram of a sequence of operations performed in the exemplary IFT block illustrated in FIG. 12A.

FIG. 13 is a process flow diagram of an embodiment method for fine timing acquisition.

FIGS. 14A and 14B are process flow diagrams of two embodiment methods for selecting a length of a detection window based upon measurements of channel delay spread.

FIG. 15 is a component block diagram of a mobile device suitable for use in an embodiment.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any embodiment described herein as “exemplary” is not necessarily to be construed as preferred or advantageous over other embodiments.

The term synchronization in this disclosure refers to a process performed by the receiver to obtain frame and symbol timing. The receiver may also perform other tasks, such as frequency error estimation and channel estimation. Synchronization can occur at different times to improve timing and correct for changes in the channel. Quickly performing synchronization eases acquisition of the signal.

Specific details are given in the following description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The synchronization techniques described herein may be used for various multi-carrier systems and for the downlink as well as the uplink. The downlink (or forward link) refers to the communication link from the base stations to the wireless receivers, and the uplink (or reverse link) refers to the communication link from the wireless receivers to the base stations. For clarity, these techniques are described below for the downlink in an orthogonal frequency division multiplexing (OFDM) system. The pilot detection structure is well suited for a broadcast system but may also be used for non-broadcast systems.

The various embodiments described herein are particularly useful in communication systems in which the TDM pilot 2 consists of two periods in the time domain, each containing 2048 samples. This signal constellation leads to channel estimates based on TDM pilot 2 that may be 2048 samples long, and the sliding window used to detect the TDM2 signal (which is also referred to as the TDM2 detection window) can be full size (i.e., 1024 samples long) or half-size (i.e., 512 samples long). However, the various embodiments may be scaled to any number of periods of TDM pilot 2, and to any length of those periods in time domain. Accordingly, if the TDM pilot 2 consists of S time-domain periods, of length N each, the full-size sliding window applied on the channel estimate obtained from this pilot is N/2 samples long, while the half-size window is N/4 samples long. More generally, the embodiments may accommodate any arbitrary window length as long as the length is shorter than N/2 samples and is sized in such a way as to minimize the overhead between the expected delay spread and the window length.

As used herein, the terms “receiver device” and “receiver” refer to any one or all of wireless communication receivers configured to receive wireless communication signals transmitted in using OFDM encoding and modulation. Such receiver devices may include mobile multimedia broadcast receivers, cellular telephones, and similar personal electronic devices which include receiver circuitry capable of demodulating OFDM symbols, and a programmable processor and memory.

The various embodiments relate to data communication and synchronization in an information transport system using orthogonal frequency division multiplexing (OFDM). An OFDM communication system may use a transmission structure in which data is transmitted in frames or superframes, with each frame having a particular time duration. Different types of data (e.g., traffic/packet data, overhead/control data, pilot, and so on) may be sent in different parts of each frame. The term “pilot” generically refers to data and/or transmission patterns that are known in advance by both the transmitter and a receiver, and therefore can be recognized by the receiver as communicating predetermined information, such as a timing or synchronization pattern.

A receiver configured to receive OFDM signals typically needs to obtain accurate frame and symbol timing in order to properly recover the data sent by the transmitter. For example, the receiver may need to know the start of each frame in order to properly recover the different types of data sent in the frame. The receiver often does not know the time at which each OFDM symbol is sent by the transmitter nor the propagation delay introduced by the communication channel, or has a system clock that is out of synch with the time standard used by the transmitter. This is particularly true when the receiver's receiver circuitry is first energized. The receiver needs to ascertain the timing of each OFDM symbol received via the communication channel in order to properly perform the complementary OFDM demodulation of the received OFDM symbol.

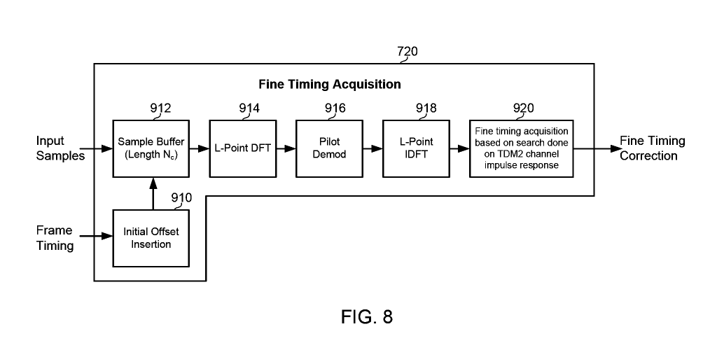

As used herein, the term “timing synchronization” refers to a general process performed by the receiver to obtain frame and symbol timing, and may also include synchronizing a receiver clock with the broadcast signal. The receiver may also perform other tasks, such as frequency error estimation and channel estimation. Synchronization can occur at different times to improve timing and correct for changes in the channel. Quickly performing synchronization eases acquisition of the signal by the receiver. In general, there may be three levels of timing synchronization: (1) frame timing acquisition; (2) fine timing acquisition; and (3) data mode time tracking. Frame timing acquisition involves obtaining a rough estimate of the beginning location of the frame in time (i.e., frame beginning). A detector for generating a fine timing correction is described below with reference to FIG. 8, in which the fine timing acquisition module 920 corresponds to the block diagram of the fine timing acquisition (FTA). In this special case, the sample buffer 912 shown in FIG. 8 is of length N_{c}=L. In general, a structure similar to that shown in FIG. 8 may also be used for other types of timing synchronization, for example, data mode time tracking. In MediaFLO, the TDM pilot-1 is used for frame timing acquisition. Data mode time tracking (DMTT), or data timing synchronization, involves retaining the timing synchronization after it has been acquired. Fine timing acquisition involves refining the rough timing estimate of the TDM pilot-2 and is the subject of the various embodiments.

One embodiment provides a method for synchronizing timing of a receiver to a received orthogonal frequency division multiplexing (OFDM) signal. In a first timing acquisition step within this process, a first timing acquisition may be performed with a first received time division multiplexed (TDM) pilot to determine a course timing estimate of the received OFDM signal. A second timing acquisition may be performed with a second TDM pilot to determine a fine timing estimate for an OFDM symbol of the received OFDM signal. The first TDM pilot may be received before the second TDM pilot, and the fine timing estimate may be a refinement of the course timing estimate. In the second timing acquisition step in this process, the accumulated energy of channel taps over a detection window may be determined and a trailing edge of the accumulated energy curve detected. In an alternative embodiment, one or both of the leading and trailing edges can be determined in the second timing acquisition step. The symbol boundary location is adjusted according to the second timing acquisition step.

The various embodiment systems and methods provide an improved receiver apparatus and acquisition algorithm using TDM pilots. The timing acquisition method presented provides capability for adapting to changing channel conditions in particular varying expected delay spreads (DS). The information on an expected delay spread can be fed back to the initial acquisition algorithm based on previous successful attempts. This information can be fixed for a particular location, or a particular market during a particular period of time. Based on the delay spread information, the algorithm for processing the specialized TDM pilot can adaptively modify the timing acquisition parameters for more robust performance under interference conditions.

Adapting the timing acquisition method to the channel conditions, in particular the channel delay spread can add robustness of the timing acquisition to thermal noise and other sources of interference. Certain embodiments of timing acquisition algorithms depend on pilot symbols for channel estimation, and use the obtained channel impulse response to adjust the system timing. One of the methods for fine timing relies on detecting the useful channel information within the time-domain channel estimate obtained using the TDM pilot-2 symbols. If a tight upper bound on the expected channel delay spread (DS)—which is the time elapsed between receiving the first and the last signal reflection—is known, the fine timing synchronization algorithm becomes more robust to various sources of interference, as will become evident below.

The result of the initial timing acquisition, based on time division multiplexed (TDM) pilot 1 processing, is a coarse timing estimate. The course timing estimate provides information about the beginning of a superframe, and gives a coarse estimate of the beginning of the TDM pilot 2. With further timing estimation using the TDM pilot 2 structure, the receiver estimates the exact starting position of subsequent OFDM symbols. This step is called fine timing acquisition (FTA). A side product of this computation is a channel estimate which can be used to initialize the channel estimation block.

This algorithm was initially designed to successfully handle the channels with delay spreads of up to 1024 chips or samples in one embodiment. Inaccuracies of the initial coarse timing estimates were corrected such that coarse timing errors anywhere between −K and +1024−K chips were corrected in one embodiment. In another embodiment, the errors between −256 and +768 chips could be corrected. The FTA processing is designed in such way that the timing corrections are available by the time they need to be applied. In other words, the FTA is completed before the next symbol is received.

In one embodiment, the TDM pilot 2 symbol includes a cyclic prefix followed by two identical pilot-2 sequences in the time domain. The receiver collects at least N_{C}=N_{FFT}/2 or 2048 samples in a sample window from a position that is determined based on the coarse timing and the initial deliberate offset introduced to avoid collecting data from neighboring symbols, where N_{FFT} could have different values in different embodiments. The 2048 samples correspond to a cyclic shift of one TDM pilot 2 sequence period, convolved with the channel. After a L-point FFT, a pilot demodulation and an IFFT, what remains is a cyclic shift of the channel impulse response.

Next, the beginning of the channel impulse response in this 2048-long cyclically-shifted image is determined. The complete channel energy is contained within a detection window of length 1024. If the channel is shorter than 1024 chips, there are several consecutive positions of the energy window that result in maximum energy. In this case, the algorithm picks the last position of a tap energy curve, since this generally corresponds to first arriving path (FAP) of the channel. This is achieved by considering a convex combination of the running energy sum and a local finite difference of order N_{D}. Once the location of the FAP is located in the 2048-long shifted channel estimate, this information is readily converted to a timing offset that is applied when sampling the subsequent OFDM symbols.

In a related set of operations during the process of timing synchronization, channel delay spread is also estimated. In one embodiment, the information on the upper bound of such delay spread can be fed back to the fine timing acquisition algorithm in order to further fine-tune the length of the detection window. Due to a principle not very different from that of matched filtering, the channel location detection errors due to thermal noise or other sources of interference on the channel estimate can be shown to be reduced if the length of the detection window closely corresponds to the maximum expected delay spread of the channel. Since the described algorithm can operate adaptively, whereas the currently observed channel delay spread conditions are continuously fed to the FTA algorithm, this process can continue to yield improved timing synchronization results compared to the originally disclosed method.

The accuracy in timing synchronization is achieved by tying it to the channel estimates and incorporating both an accumulated tap energy curve and its first derivative in detecting the FAP. At the same time, this results in robustness of this method to excess delay spreads. The repetitive structure of the TDM pilot 2 produces the cyclic shifts of the channel estimates. There is a simple one-to-one correspondence between these cyclic shifts and timing offsets. The structure of TDM pilot 2 symbol and the initial offsets that are deliberately introduced make the system more robust to the errors of coarse timing acquisition estimates. Finally, the architecture of the FTA operation in a symbol timing searcher block, and its intermesh to the IFFT block, makes it computationally efficient and allows for the stringent computational time requirements to be met in one embodiment.

Additionally, if the estimated delay spread is shorter than one quarter of the channel estimate obtained using TDM pilot 2, namely shorter than 512 samples, a computationally efficient hardware structure may be implemented to minimize the hardware complexity and reduce the computational time. More generally, any duration shorter than N/2 can be accommodated. However, for ease of description, only the N/2 and N/4 implementations are described in detail.

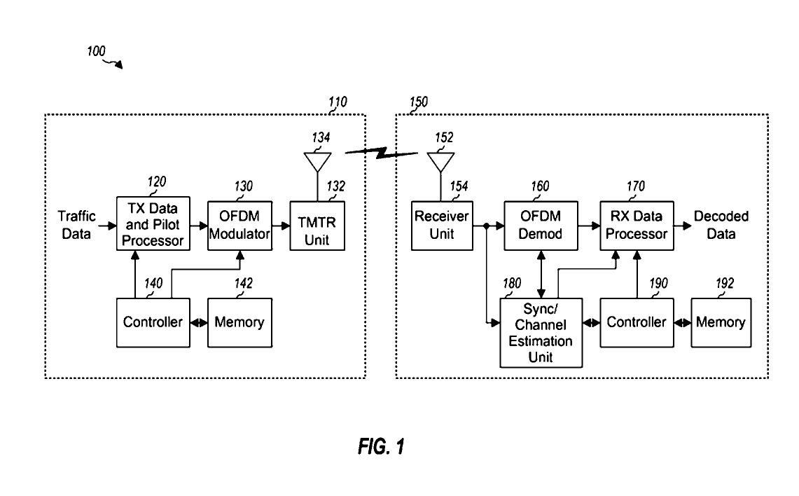

FIG. 1 illustrates a block diagram of a base station 110 and a wireless receiver 150 in an OFDM system 100 according to an embodiment. The base station 110 is generally a fixed station and may also be referred to as a base transceiver system (BTS), an access point, or by some other term. Wireless receiver 150 may be fixed or mobile and may also be referred to as a user terminal, a mobile station, or by some other term. The wireless receiver 150 may also be a portable unit such as a cellular phone, a handheld device, a wireless module, a personal digital assistant (PDA), a television receiver, and so on.

At the base station 110, a transmitter (TX) data and pilot processor 120 receives different types of data (e.g., traffic/packet data and overhead/control data) and processes (e.g., encodes, interleaves, and symbol maps) the received data to generate data symbols. As used herein, a “data symbol” is a “modulation symbol” for data, a “pilot symbol” is a modulation symbol for a pilot, and a modulation symbol is a complex value for a point in a signal constellation for a modulation scheme (e.g., M-PSK, M-QAM, and so on). The pilot processor 120 also processes pilot data to generate pilot symbols and provides the data and pilot symbols to an OFDM modulator 130.

The OFDM modulator 130 multiplexes the data and pilot symbols onto the proper sub-bands and symbol periods and performs OFDM modulation on the multiplexed symbols to generate OFDM symbols, as described in more detail below. A transmitter (TMTR) unit 132 converts the OFDM symbols into one or more analog signals and further condition (e.g., amplifies, filters, frequency upconverts, etc.) the analog signal(s) to generate a modulated signal. The base station 110 transmits the modulated signal from an antenna 134 for reception by wireless receivers in the OFDM system 100.

At the wireless receiver 150, the transmitted signal from base station 110 is received by an antenna 152 and provided to a receiver unit 154. The receiver unit 154 conditions (e.g., filters, amplifies, frequency downconverts, etc.) the received signal and digitizes the conditioned signal to obtain a stream of input samples. An OFDM demodulator 160 performs OFDM demodulation on the input samples to obtain received data and pilot symbols. OFDM demodulator 160 also performs detection (e.g., matched filtering) on the received data symbols with a channel estimate (e.g., a frequency response estimate) to obtain detected data symbols, which are estimates of the data symbols sent by base station 110. OFDM demodulator 160 provides the detected data symbols to a receive (RX) data processor 170.

A synchronization/channel estimation unit (SCEU) 180 receives the input samples from the receiver unit 154 and performs synchronization to determine frame and symbol timing, as described below. The SCEU 180 also derives the channel estimate using received pilot symbols from the OFDM demodulator 160. The SCEU 180 provides the symbol timing and channel estimate to the OFDM demodulator 160 and may provide the frame timing to the RX data processor 170 and/or a controller 190. The OFDM demodulator 160 uses the symbol timing to perform OFDM demodulation and uses the channel estimate to perform detection on the received data symbols.

RX data processor 170 processes (e.g., symbol demaps, deinterleaves, decodes, etc.) the detected data symbols from OFDM demodulator 160 and provide decoded data. RX data processor 170 and/or controller 190 may use the frame timing to recover different types of data sent by base station 110. In general, the processing by OFDM demodulator 160 and RX data processor 170 is complementary to the processing by OFDM modulator 130 and TX data and pilot processor 120, respectively, at base station 110.

Controllers 140, 190 may direct operations at the base station 110 and a wireless receiver 150, respectively. The controllers 140, 190 may be processors and/or state machines. Memory units 142, 192 may provide storage for program codes and data used by controllers 140 and 190, respectively. The memory units 142, 192 may use various types of storage medium to store information.

The base station 110 may send a point-to-point transmission to a single wireless receiver, a multi-cast transmission to a group of wireless receivers, a broadcast transmission to all wireless receivers under its coverage area, or any combination thereof. For example, base station 110 may broadcast pilot and overhead/control data to all wireless receivers under its coverage area. Base station 110 may further single-cast transmit user-specific data to specific wireless receivers, multi-cast data to a group of wireless receivers, and/or broadcast data to all wireless receivers in various situations and embodiments.

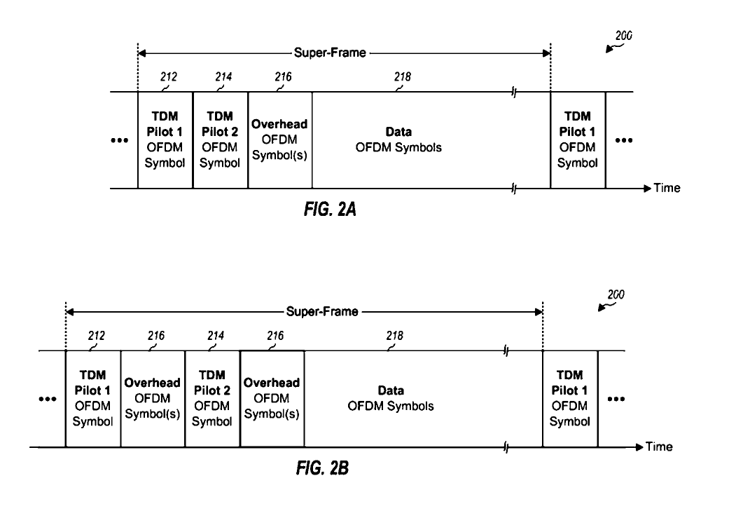

FIG. 2A illustrates a diagram of a super-frame structure 200 that may be used for OFDM system 100. Data and pilots may be transmitted in frames or super-frames, with each frame or super-frame having a predetermined time duration. A super-frame may also be referred to as a frame, a time slot, or some other terminology. In this embodiment, each super-frame includes a TDM pilot 1 field 212 for a first TDM pilot, a TDM pilot 2 field 214 for a second TDM pilot, an overhead field 216 for overhead/control data, and a data field 218 for traffic/packet data.

The four fields 212 through 218 are time division multiplexed in each super-frame such that only one field is transmitted at any given moment. The four fields are also arranged in the order shown in FIG. 2 to facilitate synchronization and data recovery. Pilot OFDM symbols in pilot fields 212 and 214, which are transmitted first in each super-frame, may be used for detection of overhead OFDM symbols in field 216, which is transmitted next in the super-frame. Overhead information obtained from field 216 may then be used for recovery of traffic/packet data sent in data field 218, which is transmitted last in the super-frame.

In an embodiment, TDM pilot 1 field 212 carries one OFDM symbol for TDM pilot 1, and TDM pilot 2 field 214 also carries one OFDM symbol for TDM pilot 2. In general, each field may be of any duration, and the fields may be arranged in any order. TDM pilots 1 and 2 are broadcast periodically in each frame to facilitate synchronization by the wireless receivers. Overhead field 216 and/or data field 218 may also contain pilot symbols that are frequency division multiplexed with data symbols, as described below.

The OFDM system 100 has an overall system bandwidth of BW MHz, which is partitioned into N orthogonal subbands using OFDM. The spacing between adjacent subbands is BW/N MHz. Of the N total subbands, M subbands may be used for pilot and data transmission, where M<N, and the remaining N−M subbands may be unused and serve as guard subbands. In an embodiment, the OFDM system uses an OFDM structure with N=4096 total subbands, M=4000 usable subbands, and N−M=96 guard subbands. In general, any OFDM structure with any number of total, usable, and guard subbands may be used for the OFDM system.

TDM pilots-1 and 2 may be designed to facilitate synchronization by the wireless receivers in the system. A wireless receiver may use TDM pilot 1 to detect the start of each frame, obtain a coarse estimate of symbol timing, and estimate frequency error. The wireless receiver may use TDM pilot 2 to obtain more accurate symbol timing.

FIG. 2B illustrates a diagram of another embodiment of a super-frame structure 200 that may be used for an OFDM system 100. This embodiment follows TDM pilot-1 212 with TDM pilot-2 214, with overhead OFDM symbols 216 added in-between. The number and duration of overhead symbols are known such that synchronization to the TDM pilot-1 symbol 212 allows estimating where the TDM pilot-2 symbol will begin.

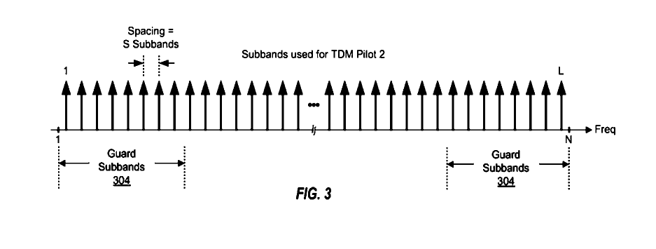

FIG. 3 illustrates a diagram of an embodiment of a TDM pilot-2 214 in the frequency domain. For this embodiment, TDM pilot-2 214 comprises L pilot symbols that are transmitted on L subbands. The L subbands are uniformly distributed across the N total subbands and are equally spaced apart by S subbands, where S=N/L. For example, N=4096, L=2048, and S=2. Other values may also be used for N, L, and X. It is worth noting that in any OFDM waveform, when the separation between the two non-zero subbands in the frequency domain is S=N/L, in time domain there will be S time domain periods. This structure for TDM pilot-2 214 can provide accurate symbol timing in various types of channels including a severe multi-path channel. The wireless receivers 150 may also be able to: (1) process TDM pilo-2 214 in an efficient manner to obtain symbol timing prior to the arrival of the next OFDM symbol, which is right after TDM pilot 2 in one embodiment, and (2) apply the symbol timing to this next OFDM symbol, as described below. The L subbands for TDM pilot-2 are selected such that S identical pilot-2 sequences are generated for the TDM pilot-2 214.

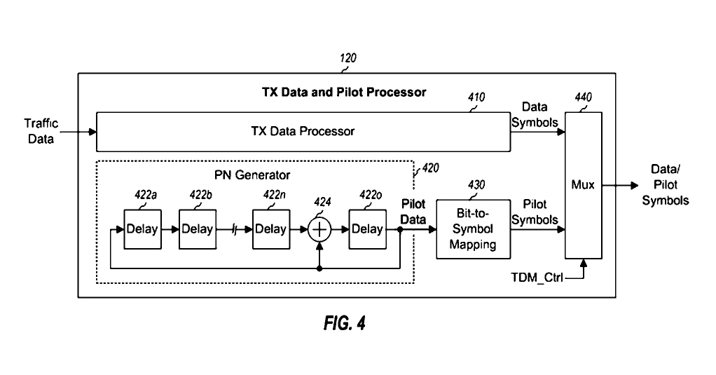

FIG. 4 illustrates a block diagram of TX data and pilot processor 120 of the base station 110 according to an embodiment. Within the pilot processor 120, a TX data processor 410 receives, encodes, interleaves, and symbol maps traffic/packet data to generate data symbols.

A bit-to-symbol mapping unit 430 receives the pilot data from PN generator 420 and maps the bits of the pilot data to pilot symbols based on a modulation scheme. The same or different modulation schemes may be used for the pilots 212, 214. In an embodiment, QPSK is used for both TDM pilots 1 and 2. In this case, mapping unit 430 groups the pilot data into 2-bit binary values and further maps each 2-bit value to a specific pilot modulation symbol. Each pilot symbol is a complex value in a signal constellation for QPSK. If QPSK is used for the TDM pilots, then mapping unit 430 maps 2L₁ pilot data bits for TDM pilot 1 to L₁ pilot symbols and map 2L₂ pilot data bits for TDM pilot 2 to L₂ pilot symbols. A multiplexer (Mux) 440 receives the data symbols from TX data processor 410, the pilot symbols from mapping unit 430, and a TDM Ctrl signal from controller 140. Multiplexer 440 provides to the OFDM modulator 130 the pilot symbols for the pilots 212, 214 and the data symbols for the overhead and data fields of each frame, as shown in FIGS. 2A and 2B.

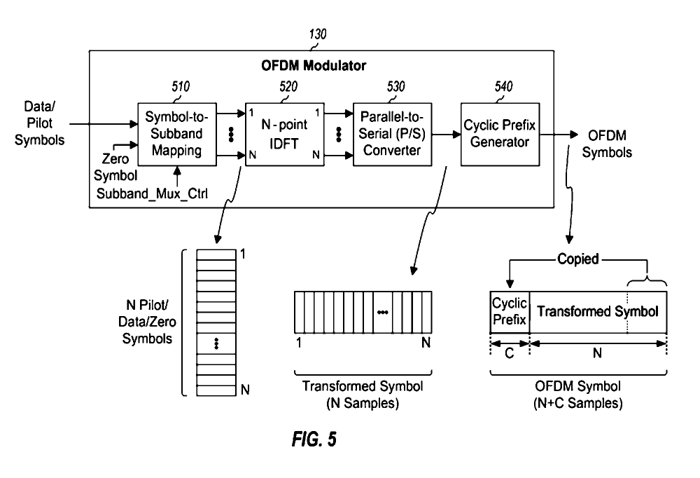

FIG. 5 illustrates a block diagram of the OFDM modulator 130 of the base station 110 according to an embodiment. A symbol-to-subband mapping unit 510 receives the data and pilot symbols from TX data and pilot processor 120 and maps these symbols onto the proper subbands based on a Subband Mux Ctrl signal from controller 140. In each OFDM symbol period, the mapping unit 510 provides one data or pilot symbol on each subband used for data or pilot transmission and a “zero symbol” (which is a signal value of zero) for each unused subband. The TDM pilot symbols 212, 214 designated for subbands that are not used are replaced with zero symbols. For each OFDM symbol period, mapping unit 510 provides N “transmit symbols” for the N total subbands, where each transmit symbol may be a data symbol, a pilot symbol, or a zero symbol.

An inverse discrete Fourier transform (IDFT) unit 520 receives the N transmit symbols for each OFDM symbol period, transforms the N transmit symbols to the time domain with an N-point IDFT, and provides a “transformed” symbol that contains N time-domain samples. Each sample is a complex value to be sent in one sample period. An N-point inverse fast Fourier transform (IFFT) may also be performed in place of an N-point IDFT if N is a power of two, which is typically the case.

A parallel-to-serial (P/S) converter 530 serializes the N samples for each transformed symbol. A cyclic prefix generator 540 then repeats a portion (or C samples) of each transformed symbol to form an OFDM symbol that contains N+C samples. For example, the cyclic prefix is the last 512 samples of the OFDM symbol. The cyclic prefix is used to combat inter-symbol interference (ISI) and intercarrier interference (ICI) caused by a long delay spread in the communication channel. Generally, delay spread is the time difference between the FAP and the latest arriving path (LAP) at a receiver 150. An OFDM symbol period (or simply, a “symbol period”) is the duration of one OFDM symbol and is equal to N+C sample periods.

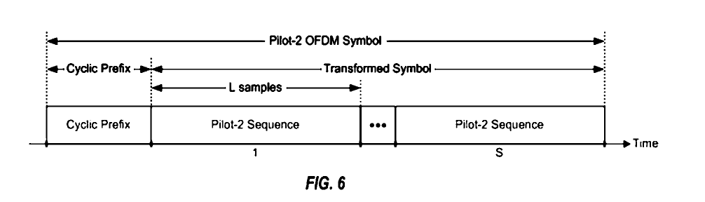

FIG. 6 illustrates a diagram of a time-domain representation of TDM pilot 2 according to an embodiment. An OFDM symbol for TDM pilot 2 (or “pilot-2 OFDM symbol”) is also composed of a transformed symbol of length N and a cyclic prefix of length C. The transformed symbol for TDM pilot 2 contains X identical pilot-2 sequences, with each pilot-2 sequence containing L time-domain samples. The cyclic prefix for TDM pilot 2 is composed of the C rightmost samples of the transformed symbol and is inserted in front of the transformed symbol. For example, if N=4096, L=2048, X=2, and C=512 then the pilot-2 OFDM symbol would contain two complete pilot-2 sequences, with each pilot-2 sequence containing 2048 time-domain samples. The cyclic prefix for TDM pilot 2 would contain only a portion of the pilot-2 sequence.

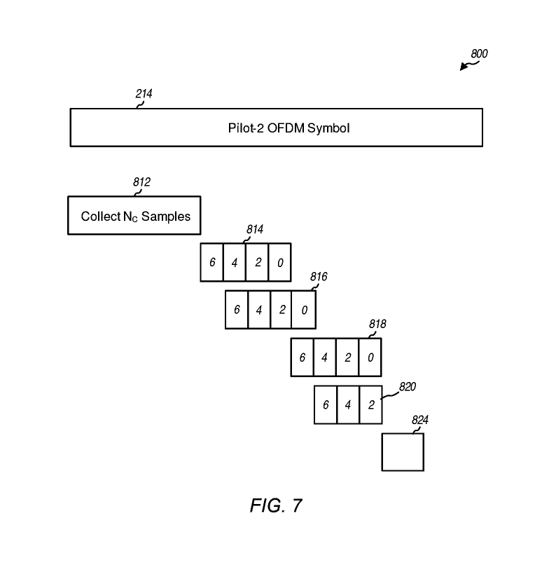

FIG. 7 illustrates a block diagram of a timeline 800 for an FTA according to an embodiment. FAP detection, or channel location search is performed as the last stage of FTA. In the depicted portion of the process, a sample window of length N_{C} is gathered in step 812. Next, a N_{C}-point FFT is performed upon the sample window in step 814, where N_{C} is 2048 in this example and there are four. The FFT is done in a cascade of 512-point FFTs using the interlace sequence 6, 4, 2, and 0. The pilot information is demodulated and extrapolated from the subcarriers in step 816 in the same interlace sequence. A N_{C}-point IFFT is performed in step 818 on the demodulated pilot as a cascade of 512-point IFFTs using the same interlace sequence. A twiddle multiply on the 6, 4 and 2 interlaces begins after step 816 completes. The FTA search is initialized in step 820 to begin the process of finding the FAP. This pipelined process is further described below and allows more quickly determining FAP.

FIG. 8 illustrates a block diagram of fine timing acquisition detector 720 according to an embodiment. In this embodiment, the fine timing acquisition detector 720 produces a fine timing correction based on the TDM pilot-2 OFDM symbol. Within fine timing acquisition detector 720, a sample buffer 912 receives the input samples from the receiver unit 154 and stores a “sample” window of L input samples for the TDM pilot-2 OFDM symbol. The start of the sample window is determined by an initial offset insertion unit 910 starting from the frame timing provided by the frame detector 710. The sample buffer is then processed by an L-point discrete Fourier transform (DFT) 914 which outputs to a pilot demodulator 916 which outputs to an L-point inverse discrete Fourier transform (IDFT), which outputs to a fine timing acquisition processing module 920 which accomplishes fine timing acquisition based on a search done on TDM pilot-2 channel impulse response, the output of which is a fine timing correction signal.

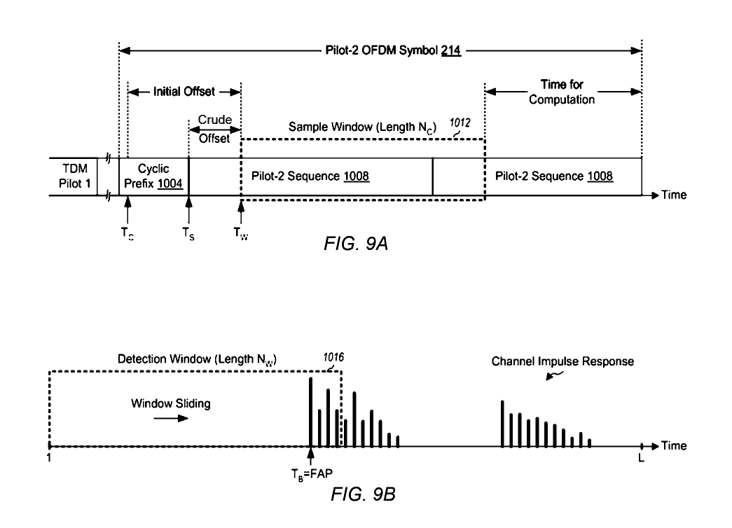

FIG. 9A illustrates a timing diagram of the processing for the pilot-2 OFDM symbol according to an embodiment. A frame detector can provide the coarse symbol timing which includes error T_{C} based on the pilot-1 OFDM symbol. An offset insertion block may determine T_{W} to position the sample window 1012. The pilot-2 OFDM symbol contains S identical pilot-2 sequences where each has a length, L (e.g., two pilot-2 sequences of length 2048 if N=4096 and L=2048). A sample window 1012 of N_{c} input samples is collected by sample buffer 912 for the pilot-2 OFDM symbol starting at location T_{W}. The fine timing algorithm seeks to define the error in the course symbol timing (i.e., T_{C}).

The start of the sample window 1012 is delayed by an initial offset OSᵢₙᵢₜ from the coarse symbol timing, T_{C}, or T_{W}=T_{C}+OSᵢₙᵢₜ. The initial offset does not need to be especially accurate and is selected to ensure that one complete pilot-2 sequence is collected in sample buffer 912 despite possible errors in the course timing estimate. The initial offset may also be selected to be small enough such that the processing for the pilot-2 OFDM symbol can be completed before the arrival of the next OFDM symbol, so that the symbol timing obtained from the pilot-2 OFDM symbol may be applied to this next OFDM symbol.

FIG. 9B illustrates a diagram of the L-tap channel impulse response from the IDFT unit 918 according to an embodiment. The impulse response shows the cyclic shift in the channel estimate. Each of the L taps is associated with a complex channel gain at that tap delay. The channel impulse response may be cyclically shifted, which means that the tail portion of the channel impulse response may wrap around and appear in the early portion of the output from IDFT unit 918.

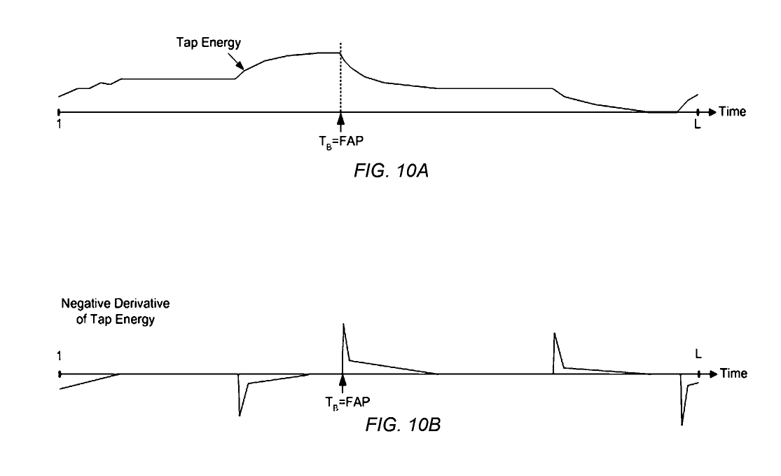

A fine timing acquisition module 920 may determine the fine timing correction based on the search done on the TDM pilot-2 symbol impulse response. The fixed point functionality of the fine timing acquisition module 920 may be divided into two subsections: a block for channel location and a block for fine timing correction. This detection of the beginning of the channel energy may be achieved by sliding a “detection” window 1016 of length N_{W} across the channel impulse response, as indicated in FIG. 9B. The detection window size may be determined as described below. In one embodiment, N_{W} can be chosen as a tight upper bound on the estimated channel delay spread, DS. At each window starting position, the energy of all taps falling within the detection window is computed to find the tap energy shown as a curve in FIG. 10A.

FIG. 10A illustrates a plot of the accumulated energy at different window starting positions according to an embodiment. The detection window is shifted to the right circularly so that when the right edge of the detection window reaches the last tap at index N_{C}, the window wraps around to the first tap at index 1. Energy is thus collected for the same number of channel taps for each detection window starting position.

The detection window size N_{W} may be selected based on the expected delay spread of the system. The delay spread at a wireless receiver is the time difference between the earliest and latest arriving signal components at the wireless receiver. The delay spread of the system is the largest delay spread among all wireless receivers in the system. If the maximum detection window size is equal to or larger than the delay spread of the system, then this detection window, when properly aligned, would capture all of the energy of the channel impulse response. In locations where the delay spread at a wireless receiver is significantly shorter, the detection window size may be reduced to reduce the probability of detection error. The detection window size N_{W} may also be selected in one embodiment to be no more than half of N_{C} (or N_{W}≦N_{C}/2) to avoid ambiguity in the detection of the beginning of the channel impulse response. In another embodiment, the window size N_{W} may be adapted according to the estimated value of the delay spread DS so as not to surpass the maximum value N/2. In fact, even N/2 can be surpassed, but this method requires some further assumptions on the channel behavior. Since these assumptions can typically not be posed right after initial timing acquisition, limiting N_{w} to N/2 may be sufficient in this context.

FIG. 10B shows an example of the negative derivative of the accumulated energy curve. The beginning of the channel impulse response or FAP may be detected by (1) determining the peak energy among all of the detection window 1016 starting positions as shown in the accumulated energy curve of FIG. 10A, and (2) identifying the rightmost detection window 1016 starting position with the peak energy, if multiple window starting positions have the same or similar peak energies. A scoring value Vₙ for an n^{th} detection window location can be derived from a weighted sum of the tap energy in the detection window 1016 and a finite difference from the maximum tap energy curve. For example, a scoring value V may be computed using the following equation:

Vₙ=α*E_{n-ND}−(1−α)*Dₙ Eq. 1

where E_{n-ND} is the accumulated energy for the (n−N_{D})^{th} detection window location, α is a weighting factor, and Dₙ is the finite difference for the n^{th} detection window location which is calculated according to the formula:

$${D}_{n} = {\sum }_{i = {N}_{D}}^{2 {N}_{D} - 1} {E}_{n - i} - {\sum }_{i = 0}^{{N}_{D} - 1} {E}_{n - i} . \qquad Eq . 2$$

Maximizing this scoring value V effectively finds a trailing edge of the tap energy curve's maximum region. The energies for different window starting positions may also be averaged or filtered in a noisy channel. In any case, the beginning of the channel impulse response is denoted as FAP in FIG. 10B. Fine symbol timing corrections may be uniquely computed once the beginning of the channel impulse response T_{B} is determined. These corrections may be designed so as to bring the FAP location, or position T_{B} in FIG. 9, close to position zero of the channel estimate during next OFDM symbol.

In a further embodiment, fine timing corrections may depend on both the FAP location, as well as the estimated delay spread of the channel DS. This delay spread, DS, can be determined by finding both the leading and trailing edges of the accumulated energy curve. Similar to finding the trailing edge, the leading edge can be found by scoring a weighted sum of the accumulated energy (Eₙ) and its positive finite difference (Dₙ).

In a different embodiment, the fine timing searcher first finds the place T_{M} where the maximum accumulated energy occurs, and stores this maximum value E_{M}. Next, accumulated energy curve to the left and to the right of T_{M} is examined in an effort to locate positions where the accumulated energy drops below the value (1−b) E_{M}, for some pre-determined value b, less than one. In other words, the leading edge and the trailing edge of the accumulated energy curve is defined where the accumulated energy falls some percentage (e.g., 5% or 3%) away of its maximum over the detection window 1016. The percentage defines a band around the maximum tap energy position. Entering the band defines the leading edge of the flat portion in the band, T_{L}, while leaving the band defines the trailing edge of the flat portion in the band, T_{T}. The trailing edge coincides with the position of the first arriving path, while the leading edge is equal to the last arriving path minus N_{W}. The difference between the leading edge and the trailing edge is equal to N_{W} minus the delay spread, DS. Therefore, delay spread DS can be computed as DS=N_{W}−T_{T}−T_{L}. Once DS has been computed, fine timing corrections may be determined so that the channel content remains centered within the cyclic prefix area in the channel estimate during the next OFDM symbol.

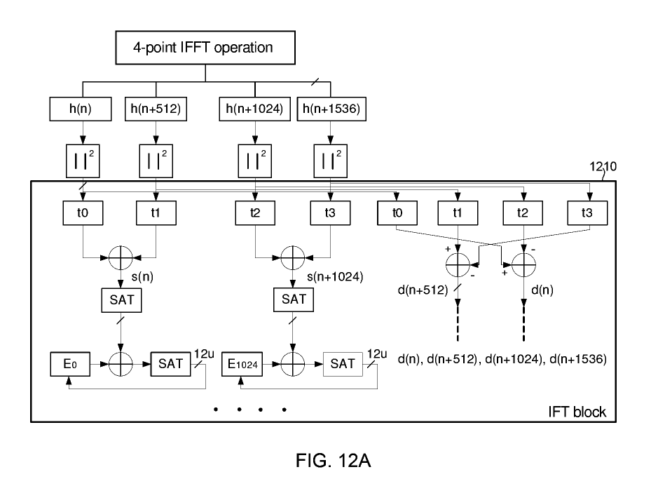

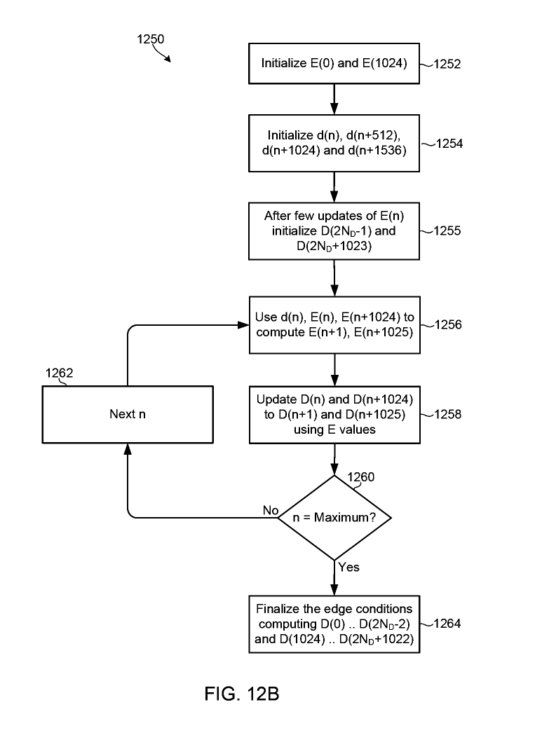

It is worth noting that since this alternative method determines the leading and trailing edges, FAP and thus the fine timing offset can also be computed using this method. This method requires a 2-pass algorithm as opposed to the first method, and thus FIG. 12 does not apply to it any longer. Also, the timing budget for this computation may not fit the needs or constraints in every implementation.

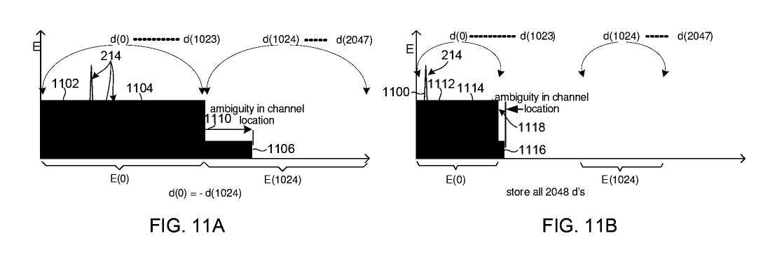

FIGS. 11A and 11B illustrate signals and detection windows involved in fine timing acquisition. This figures illustrate an communication system employing 2K channels (i.e., 2047 channels), where the channel delay spreads are known to be limited to 512 chips. These figures illustrate received energy versus time in chips (specifically from taps 0 to 2047) over the portion of the signal including all received images of the TDM pilot-2's 214. Due to multipath effects, multiple TDM pilot-2 symbols 214 will be received, beginning with the first arriving pilot (FAP) 1100. As discussed above, the beginning of the channel impulse response, or FAP, may be detected by determining the peak energy among all of the detection window starting positions, and identifying the rightmost detection window starting position with the peak energy, if multiple window starting positions have the same or similar peak energies. This is illustrated in FIG. 11A which shows the three detection windows 1102, 1104, and 1106, each 1024 chips long.

If it is assumed that the channel delay spread DS is limited to 512 chips in the 2048-long (compressed) channel estimate, it may be beneficial to perform FAP detection using a 512-long sliding window, as illustrated in FIG. 11B, instead of 1024-long sliding window as illustrated in FIG. 11A.

FIG. 11A illustrates how a detection window that is 1024 chips long is used when the delay spread is less than or equal to half that length, such as 512 chips, and lead to an ambiguity in channel location using the sliding window detection method. The detection window 1102 starts at chip 0, and thus will yield the accumulated energy value E(0). The detection window 1104 starts earlier than chip 0 such that the last arriving TDM pilot-2 1101 just fits within the end of the detection window. The detection window 1106 starts after chip 0 such that the FAP 1100 just fits within the beginning of the detection window. Thus, each sliding detection window beginning with detection window 1104 and ending with detection window 1106, will record the same accumulated energy for all of the TDM pilot-2's 214. This results in a “flat zone” 1108 in the accumulated energy graph as each incremental step in the sliding window between detection window 1104 and detection window 1106 does not cause a change maximum accumulated energy from missing any of the TDM pilot-2's 214. This “flat zone” 1108 leads to the duration of ambiguity 1110 in the channel location. Noise during the “flat zone” will cause ripples in the accumulate energy graph, which can lead to errors in detection of the FAP, errors in timing in synchronization can occur. If the flat zone is fairly long, the chance of an erroneous timing synchronization. Also, if the flat zone is long and a noise spike causes an erroneous detection of the FAP, the amount by which the FAP is off from the true FAP may be very large, leading to a large error in timing synchronization. When this happens, the time tracking algorithm may not be able to compensate, since that algorithm assumes that any error in timing synchronization is small.

In contrast, FIG. 11B illustrates how shortening the detection window reduces the ambiguity in channel location using the sliding detection window method. FIG. 11B shows the same set of TDM pilot-2's 214, but the three detection windows 1112, 1114, 1116 are 512 chips in length. As a result, the duration of ambiguity 1118 between the detection window 1114 that ends with the last arriving TDM pilot-2 1101 and the detection window 1116 that starts with the FAP 1100 is greatly reduced. This reduced duration of ambiguity simplifies the detection algorithm, and also reduces the number of different temporary internal values d(n) that must be calculated, enabling the difference values to be temporarily stored in memory for accelerating the FTA algorithm.

The benefits of reducing the length of the detection window are two-fold. First, the channel to noise ratio (C/N) captured in the accumulated energy, and thus the score computation, may improve by 3 dB. C/N is the ratio of useful signal information to interference (thermal noise and other sources of interference) present in the TDM pilot-2 channel estimate. Thus, reducing the window length reduces the amount of noise processed in the search for the TDM pilot-2.

Second, shortening the detection window length can limit the timing errors due to noisy channel estimates. This is because in single tap channels, timing errors due to noise accumulated in the “flat zone” 1108 can be as much as the length of the sliding window, as illustrated in FIG. 11A. Thus, shorter detection windows impose a tighter upper bound on residual timing errors after TDM2-processing. A separate processor or other logic unit may choose the length of the sliding window based on the deployment scenario and field data. For example, if an analysis of the received signal indicates that the channel delay spread is less than or equal to 512 chips, the detection window may be set at length 512 (i.e., N/4), as illustrated in FIG. 11B. Once chosen, the detection window length is not expected to change during operation within a particular location.

In the various embodiments, information regarding the average delay spread, DS, in the channel is used to determine the size of the detection window used for the FTA algorithm. As noted above, the delay spread can be determined by finding both the leading and trailing edges of the accumulated energy. Both the leading and trailing edges can be found by scoring a weighted sum of the accumulated energy and positive finite difference. By repeatedly determining the delay spread of the channel and averaging the results over time, an average or expected delay spread can be calculated and used for setting the detection window length. Alternatively, an average delay spread may be determined using time-weighted average channel estimates. Methods and circuits for determining average delay spread and other information useful in timing synchronization are disclosed in U.S. patent application Ser. No. ______, entitled “Methods and Systems for Timing Acquisition Robust to Channel Fading” (Attorney Docket No. 090590) which is filed concurrently herewith, the entire contents of which are hereby incorporated by reference. Using time-weighted average channel estimate information, a maximum expected delay spread can be determined, from which the detection window length can be set such that the detection window is greater than or equal to the maximum conceivable delay spread, but not longer than necessary.

When the 1024-long window is used, the IFT block may compute two running sums and scores in parallel: E(n) and E([n+1024]_{mod 2048}). The process may be jump-started by computing E(0) and E(1024), as well as the temporary internal values d(n), for n=0 to n=1023.

FIG. 12A illustrates an embodiment computation circuit for identifying the FAP for use in fine timing acquisition using two window sizes of N/2 (i.e., length 1024) and N/4 (i.e., length 512). FIG. 12B illustrates a sequence of operations 1250 that may be accomplished in the embodiment computation circuit. Further details on the operations involved in fine timing acquisition in various embodiments are provided in U.S. patent application Ser. No. 11/372,394 from which this application claims priority and which is incorporated herein by reference. The FFT architecture is used to allow for computation of the first stage of FFT processing in parallel with incoming data. An example FFT architecture is described in U.S. Pat. No. 7,551,545, that issued Aug. 11, 2005, which is incorporated by reference herein for all purposes. The FFT implementation is chosen to match the number of subbands per interlace (N_{I}). For example if pilot-2 uses N₁=512 and 4 interlaces, then the FFT implementation is chosen to be a cascade of 4×512 FFTs and the 4-point FFT is computed as the samples are received, with no extra latency.

At a start of a computation, the values of E(0) and E(1024) may be initialized, step 1252, and the values of d(n), d(n+512), d(n+1024) and d(n+1536) are initialized, step 1254. The 512 point FFT may be computed for interlaces in a specific order optimized for speed. For example, if the TDM pilot 2 is transmitted on the even subcarriers, the FFT may be performed in the following order 6, 4, 2 and 0. The pilot demodulation may be performed on an interlace by interlace basis. Once the pilot demodulation is done, the 2048 point IFFT is computed. This may be performed in three steps. First, the interlaces 6, 4, 2 and 0 are processed by a 512 point IFFT. Second, the twiddle multiplication is applied only for interlaces 6, 4 and 2. Interlace 0 does not use any twiddle multiplication. Therefore, the IFFT for interlace 0 can happen in parallel with the twiddle computation for the other interlaces, saving time. Third, a 4-point IFFT is performed to combine the 512 point IFFT outputs. After the IFFT is computed, the 4-point IFFT stage is combined with the initialization of the FAP detection algorithm. The 4-point IFFT provides the following samples of channel estimates h(i): h(n), h(n+N_{W/2}), h(n+N_{.sub.}W), h(n+3N_{W/2}), for 0≦N_{W/2-1}.

Given E(n) in the same range of indices, E(n+1) may be computed as E(n)−d(n). Notice that in the same range of n, E([n+1024+1]_{mod 2048}) may be computed as E(n+1024)+d(n). Therefore, the IFT block 1410 may only need to store temporary internal values d(n) in the range 0≦n≦1023. To enable this, additional memory is included within the IFT block 1410 or access to additional memory is provided to store the temporary internal values d(n). In an embodiment supporting a 2K implementation, this requires additional storage of 1024×12 bits.

In an embodiment, the two running sums E(n) and E([n+1024]_{mod 2048}) may be kept in parallel in order to reduce the overall computation time as illustrated in FIG. 12A. The sliding window may be of length 1024 or 512. In case of a 512 long sliding window, the definition of d(n) becomes:

d(n)=|h(n)|²−|h([n+512]_{mod 2048})|², for 0≦n≦2047 Eq. 3.

where h(n) are complex time domain channel estimate elements (“channel estimate taps”). As used herein, s(n) and d(n) are intermediate internal values that are used to compute accumulated energies En, and finite differences Dn.

After all d(n) have been computed (all 2048 values) in a phase 1 period of initial population of values, step 1255, E(n) values may be calculated and stored in memory and used for calculating initial finite difference values for D(2N_{D}−1) and D(2N_{D}+1023) using Eq. 2.

Thereafter, in a steady state of updates (phase 2 period) the calculation loops through the sample window positions n the stored values advancing the running sums as: E(n+1)=E(n)−d(n) and E(n+1024+1)=E(n+1024)−d(n+1024), in the range of indices between 0 and 1022, step 1256. Using the updated E values, the finite difference values D(n) may be updated along with calculation of the correspond V(n) values in step 1258. In this phase, the maximum V value is tracked along with the n value where V is maximized. In step 1258, the finite difference values may be calculated using the update formula:

D[n+2N_{D}]=D[n+2N_{D}−1]−E[n]+2*E[n+N_{D}]−E[n+2N_{D}−1] Eq. 4

. If the maximum n value has not been reached (i.e., determination step 1260=“No”), the next n may be selected, step 1262, and the process of calculating E(n+1) and E(n+1025) in step 1256, as well as the process of updating D(n+1) and D(n+1025) and calculating the new V(n) and V(n+1025) in step 1258 may be repeated.

Once the maximum n value is reached (i.e., determination step 1260=“Yes”), the edge conditions may be finalized in a phase 3 and the finite differences D(0). D(2N_{D}−2) and D(1024). D(2N_{D}+1022) may be calculated, along with the corresponding V(n) in step 1264. From these values, the Vₘₐₓ=V(nₘₐₓ) value may be determined along with the index nₘₐₓ corresponding to the maximum value Vₘₐₓ. In this step, the FAP is also determined from nₘₐₓ.

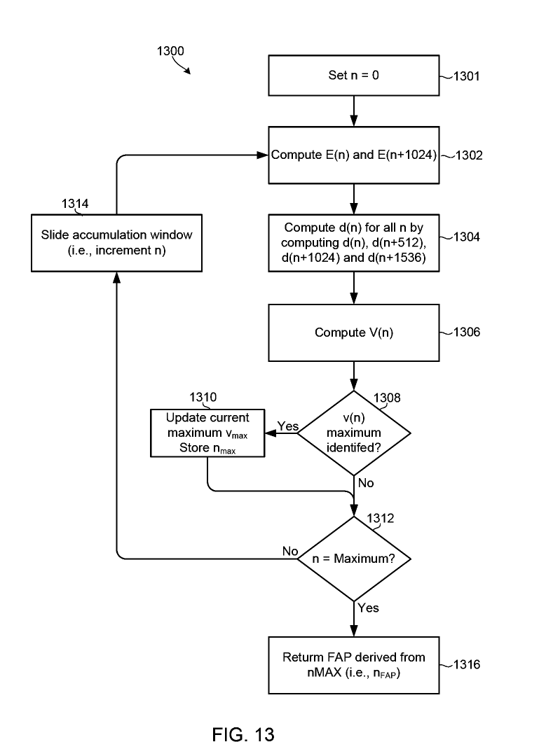

The process flow diagram in FIG. 13 illustrates a sequence 1300 of FTA operations that may be implemented when the detection window is of length 512. These operations may include the following steps. In step 1301, set n=0, and in step 1302, compute E(n) and E(n+1024), which are now defined as:

$$E ( 0 ) = {\sum }_{n = 0}^{511} {\vert h ( n ) \vert}^{2} ; E ( 1024 ) = {\sum }_{n = 1024}^{1535} {\vert h ( n ) \vert}^{2} .. \qquad Eq . 5$$

Thus, in a first pass through the loop, step 1302 computes E(0) and E(1024). Simultaneously, the hardware or software/hardware module computes d(n) for all n by computing four sets of values: d(n), d(n+512), d(n+1024) and d(n+1536) in parallel, step 1304. Each of these values may be stored in internal memory. As the detection window slides over the tap values, the circuit simultaneously computes the differences d(n) and scores V(n) according to equations 1-3, step 1306. Each of the computed scoring values V(n) may be compared to a running maximum score to determine if a new maximum score value is reached, determination 1308. The computed score V(n) may take into account the total energy received within the determination window E and information about changes in the energy d in order to accommodate noise in the signal. If the computed score V(n) exceeds a previous maximum score Vₘₐₓ (i.e., determination 1308=“Yes”), the current computed score V(n) is stored as the current maximum score Vₘₐₓ and the corresponding index n is stored as the index of that maximum score, nₘₐₓ, step 1310 If the current index may be compared to the maximum (i.e., N−1) to determine if all indexes within the determination window have been evaluated, determination 1312. So long as the increment is less than the maximum (i.e., determination 1312=“No”), the accumulation window is slid by one increment (i.e., n is incremented), step 1314, and the process repeated by returning to step 1302 to compute E(n) and E(n+1024) as described above. In sliding the accumulation window, it is noted that:

E(n+1)=E(n)−d(n), E(n+1025)=E(n+1024)−d(n+1024); 0≦n≦1022 Eq. 4.

When the last index n is reached (i.e., determination 1312=“Yes”), the process resolves the boundary values of d(n) and V(n), sets the last index of a maximum value nₘₐₓ as the index of the FAP (i.e., n_{FAP}) and returns the n_{FAP} value to the initiating process. It is noted that in this process it is possible that the maximum of V(n) is reached for more than one value of n, in which case the index n of the last maximum is considered to be the final answer. It is also possible that more than one value of V(n) is declared the maximum before the siding process is over and all the values are considered.

With the FAP detected and the FAP position n_{FAP} stored in a variable, the results can be used for applying timing correction. In this process, the integer value representing the location of the FAP of the wrap-around channel estimate is translated into the fine timing offset that is the ultimate result of the FTA algorithm.

It is worth noting that it is possible to compute fine timing offset in a two-stage process where FAP and delay spread are first computed based on one channel estimate, and then a second time based on a multitude of channel estimates averaged over time.

While the foregoing example embodiments described detection windows of length 512 and 1024 chips, the invention is not limited to these particular length of detection windows, and may be generally implemented based upon detecting channel conditions. In general, the methods and circuits described above may be used for detection windows of length Nw shorter than one-half of the channel size (e.g., N/2, N/4, N/6, N/8, etc.) tailored to the nearest integer longer than the estimated delay spread plus some safety margin. Thus, the hardware simplification in FIG. 12 can be extended to other systems which may have more lengths of the detection window than just the two shown in FIG. 12. The length of the TDM-2 symbol roughly scales with the number of sub-carriers so if the length of the channel duration is N, the detection window may be set to N/2 or N/4, which can be self adapted using the detected channel delay spread. In a further embodiment, the detection window may be any length, and not limited to N/2 or N/4.

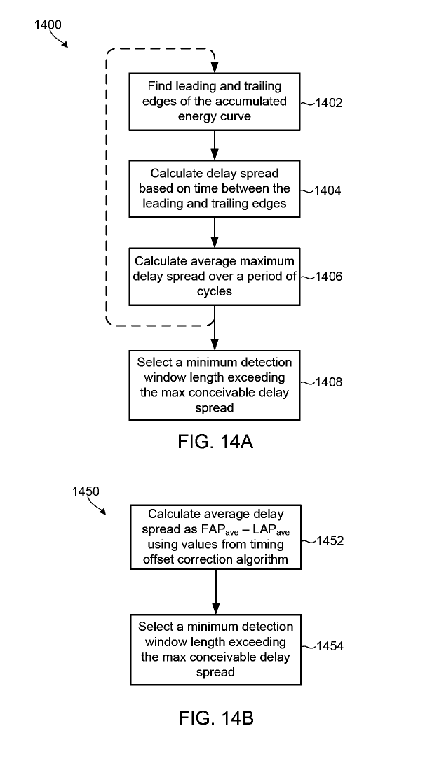

FIG. 14A illustrates an embodiment method 1400 for setting the size of the detection window based upon a maximum estimated channel delay spread. In method 1400 in step 1402, the accumulated energy curve may be analyzed to identify the leading and trailing edges as described above. Using the time difference between the leading and trailing edges of the accumulated energy curve, which define the FAP and the last arriving pilot (LAP), the delay spread of the channel can be calculated in step 1404. By repeatedly calculating the delay spread over a number of cycles, a maximum delay spread can be determined, and by determining the maximum delay spread over a period of time, an average maximum delay spread can be determined along with statistics, such as a standard deviation or standard error, of the delay spread for the channel can be calculated in step 1406. Using the channel calculated average maximum delay spread and, potentially statistics regarding its variability, the length of the detection window can be selected as a length that is greater than or equal to the maximum conceivable delay spread in step 1408. The goal of this step is to set the detection window just large enough so that it is greater than the maximum conceivable delay spread but not any larger than that. For example, the delay window could be set at a length equal to the average delay spread plus two or three standard deviations of that average, providing 96-99 percent likelihood that the delay window will encompass any delay spread that may be encountered under the current conditions.

FIG. 14B illustrates another embodiment method 1450 for setting the detection window length using information regarding an average delay spread obtained from the processes disclosed in U.S. patent application Ser. No. ______, entitled “Methods and Systems for Timing Acquisition Robust to Channel Fading” (Attorney Docket No. 090590) that is incorporated by reference above. That application discloses methods which time-average channel estimates from which time-average FAP and LAP values are determined for use in timing offset calculations to compensate for fading conditions. The time-average FAP and LAP (i.e., FAPₐᵥₑ and LAPₐᵥₑ) generated in those methods may be used to calculate an average delay spread in step 1452. For example, the average delay spread may be calculated as DSₐᵥₑ=FAPₐᵥₑ−LAPₐᵥₑ. Using this value, the system can set the detection window at a length that is greater than the maximum conceivable delay spread in step 1454, such as by multiplying the average delay spread times a factor to account for variability in the delay spread.

By implementing this process, a detection window size can be set that minimizes the flat zone, and thus reduces the magnitude of fine timing synchronization caused by noise on the channel. This process may be repeated over time to adjust the detection window size to the varying reception conditions, thereby enabling the receiver device to accommodate changes in the delay spread, as may occur when the receiver device moves from an area of relatively few sources of multi-path signals, such as may occur in the countryside, to an area of many sources of multipath signals, such as may occur in a city or mountainous area. Repeating the process periodically will also enable the detection window to be increased if

In summary, the foregoing embodiments provide an improved method for applying timing acquisition in the presence of noise by shortening the detection window based upon the information obtained by the system regarding the averaged channel length. The length of the channel estimate is determined, and the length of the detection window is set to one-half of that length. Thus, if the channel estimate is of a length of 2048, the maximum detection window length is 1024. To reduce sensitivity to noise, the detection window is sized to the size of the expected delay spread in the channel, such as two 512 chips. This reduction in the size of the detection window minimizes the flat zone in the analysis of the accumulated energy, and thus reduces the chances for fine timing errors and reduces the potential size of the error in the detection of the FAP used for timing synchronization. In this process, the values of E(n) and d(n) are calculated using equations two and three above. In this embodiment, initialization takes less time than in conventional systems. For example, when the detection window size to 512 chips, initialization takes 512 cycles instead of 1024 cycles as in previous methods. Additional memory is provided to enable storing the difference values d(n). In this embodiment, the computation of E(n+1) only involves subtractions and uses all 2048 values of d(n), simplifying and accelerating the calculation.

It should be appreciated that the various embodiments also apply to communication systems with an OFDM symbol of length 8192 (i.e., 8K systems), with the difference that the values |h(n)|² should be replaced by 4-fold compressed channel energies.

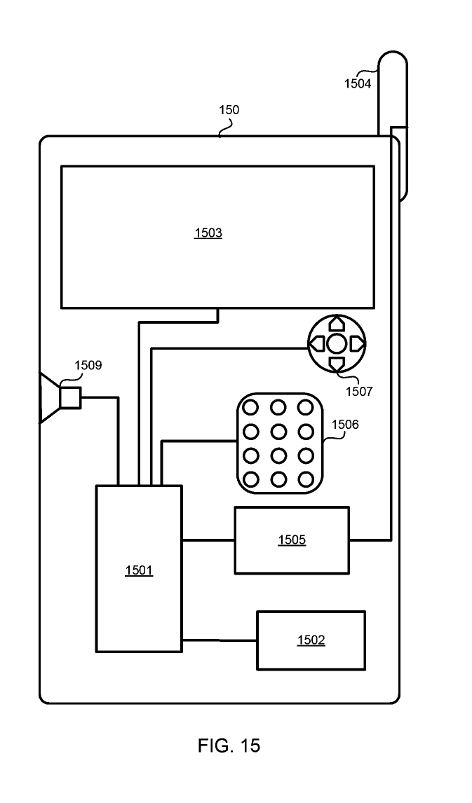

Typical wireless receivers 150 suitable for use with the various embodiments will have in common the components illustrated in FIG. 15. For example, an exemplary wireless receiver 150 may include a processor 1301 coupled to internal memory 1502, a display 1503, and to a speaker 1509. Additionally, the wireless receiver 150 may have an antenna 1504 for sending and receiving electromagnetic radiation that is connected to a wireless data link and/or cellular telephone transceiver 1505 coupled to the processor 1501. In some implementations, the transceiver 1505 and portions of the processor 1501 and memory 1502 used for cellular telephone communications are collectively referred to as the air interface since it provides a data interface via a wireless data link. Wireless receiver 150 typically also includes a key pad 1506 or miniature keyboard and menu selection buttons or rocker switches 1507 for receiving user inputs.

The processor 1501 may be any programmable microprocessor, microcomputer or multiple processor chip or chips that can be configured by software instructions (applications) to perform a variety of functions, including the functions of the various embodiments described herein. In some mobile devices, multiple processors 1501 may be provided, such as one processor dedicated to wireless communication functions and one processor dedicated to running other applications. Typically, software applications may be stored in the internal memory 1502 before they are accessed and loaded into the processor 1501. In some mobile devices, the processor 1501 may include internal memory sufficient to store the application software instructions. In many wireless receivers 150, the internal memory 1502 may be a volatile or nonvolatile memory, such as flash memory, or a mixture of both. For the purposes of this description, a general reference to memory refers to all memory accessible by the processor 1501, including internal memory 1502, removable memory plugged into the wireless receiver 150, and memory within the processor 1501 itself.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in hardware, the functionality may be implemented within circuitry of a wireless signal processing circuit that may be suitable for use in a wireless receiver or mobile device. Such a wireless signal processing circuit may include circuits for accomplishing the signal measuring and calculating steps described in the various embodiments. If implemented in software, the functions may be stored on or transmitted over as one or more instructions or code on a computer-readable medium. The steps of a method or algorithm disclosed herein may be embodied in a processor-executable software module executed which may reside on a computer-readable medium. Computer-readable media includes both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a machine readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method of timing acquisition in a wireless communication system, comprising:
receiving Time-Domain Multiplexed (TDM) pilot symbols;
determining a symbol timing based on the TDM pilot symbols;
measuring a channel delay spread after the symbol timing has been determined;
determining a maximum expected channel delay spread based upon the measured channel delay spread; and
selecting a length of a detection window to be used in future to detect the TDM pilot symbols based upon the determined maximum expected channel delay spread.

2. The method of timing acquisition of claim 1, wherein selecting a length of a detection window comprises selecting a detection window of an arbitrary length that is equal to or greater than the expected delay spread.

3. The method of timing acquisition of claim 1, wherein selecting a length of a detection window comprises selecting a nearest integer larger than the expected delay spread plus a safety margin.

4. The method of timing acquisition of claim 1, wherein selecting a length of a detection window comprises selecting a detection window length equal to N/(2*m) plus a safety margin, where m is an integer and N is a length of a channel estimate.

5. The method of timing acquisition of claim 1, wherein selecting a length of a detection window comprises selecting among two predefined detection window lengths.

6. The method of timing acquisition of claim 5, wherein the two predefined detection window lengths are 512 and 1024 chips.

7. The method of timing acquisition of claim 1, wherein the detection window length is 512 chips, the method further comprising detecting a first arriving signal path during the TDM pilot symbol by performing operations comprising:
calculating a total received energy E(n) over the detection window for a window positioned at increment 0 and at increment 1024;
calculating temporary internal values d(n) for each of n, n+512, n+1024, n+1536 using a formula d(n)=|h(n)|²−|h([n+512]_{mod 2048})|², for 0≦n≦2047, where h(n) is a channel estimate at increment n;
using temporary internal values d(n) and the computed received energy E for increments n and n+1024 to compute received energy E for increments n+1 and n+1025;
calculating a finite difference value D(n) for a finite difference of order N_{D} as
$${D}_{n} = {\sum }_{i = {N}_{D}}^{2 {N}_{D} - 1} {E}_{n - i} - {\sum }_{i = 0}^{{N}_{D} - 1} {E}_{n - i} ;$$
calculating a score value V(n) based on E(n) and D(n);
determining when the score value V(n) is maximized; and
determining a location of the first arriving signal path during the TDM pilot symbol using an increment n corresponding to the maximized score V(n).

8. The method of timing acquisition of claim 7, wherein:
the total received energy E at increment n is calculated using a formula:
$$E ( 0 ) = {{\sum }_{n = 0}}^{511} {\vert h ( n ) \vert}^{2} ; E ( 1024 ) = {\sum }_{n = 1024}^{1535} {\vert h ( n ) \vert}^{2} . ,$$
where h(n) is a channel estimate at increment n.

9. A wireless communication device, comprising:
a processor;
a memory coupled to the processor; and
a wireless receiver circuit coupled to the processor,
wherein the processor is configured with processor-executable instructions to perform operations comprising:
receiving Time-Domain Multiplexed (TDM) pilot symbols; and
determining a symbol timing based on the TDM pilot symbols;
measuring a channel delay spread after the symbol timing has been determined;
determining a maximum expected channel delay spread based upon the measured channel delay spread; and
selecting a length of a detection window to be used in future to detect the TDM pilot symbols based upon the determined maximum expected channel delay spread.

10. The wireless communication device of claim 9, wherein the processor is configured with processor-executable instructions such that selecting a length of a detection window comprises selecting a detection window of an arbitrary length that is equal to or greater than the expected delay spread.

11. The wireless communication device of claim 9, wherein the processor is configured with processor-executable instructions such that selecting a length of a detection window comprises selecting a nearest integer larger than the expected delay spread plus a safety margin.

12. The wireless communication device of claim 9, wherein the processor is configured with processor-executable instructions such that selecting a length of a detection window comprises selecting a detection window length equal to N/(2*m) plus a safety margin, where m is an integer and N is a length of a channel estimate.

13. The wireless communication device of claim 9, wherein the processor is configured with processor-executable instructions such that selecting a length of a detection window comprises selecting among two predefined detection window lengths.

14. The wireless communication device of claim 13, wherein the two predefined detection window lengths are 512 and 1024 chips.

15. The wireless communication device of claim 9, wherein the detection window length is 512 chips, and wherein the processor is configured with processor-executable instructions to perform operations further comprising detecting a first arriving signal path during the TDM pilot symbol by performing operations comprising:
calculating a total received energy E(n) over the detection window for a window positioned at increment 0 and at increment 1024;
calculating temporary internal values d(n) for each of n, n+512, n+1024, n+1536 using a formula d(n)=|h(n)|²−|h([n+512]_{mod 2048})|², for 0≦n≦2047, where h(n) is a channel estimate at increment n;
using temporary internal values d(n) and the computed received energy E for increments n and n+1024 to compute received energy E for increments n+1 and n+1025;
calculating a finite difference value D(n) for a finite difference of order N_{D} as
$${D}_{n} = {\sum }_{i = {N}_{D}}^{2 {N}_{D} - 1} {E}_{n - i} - {\sum }_{i = 0}^{{N}_{D} - 1} {E}_{n - i} ;$$
calculating a score value V(n) based on E(n) and D(n);
determining when the score value V(n) is maximized; and
determining a location of the first arriving signal path during the TDM pilot symbol using an increment n corresponding to the maximized score V(n).

16. The wireless communication device of claim 15, wherein the processor is configured with processor-executable instructions such that the total received energy E at increment n is calculated using a formula:
$$E ( 0 ) = {\sum }_{n = 0}^{511} {\vert h ( n ) \vert}^{2} ; E ( 1024 ) = {\sum }_{n = 1024}^{1535} {\vert h ( n ) \vert}^{2} . ,$$
where h(n) is a channel estimate at increment n.

17. A wireless communication device, comprising:
means for receiving Time-Domain Multiplexed (TDM) pilot symbols; and
means for determining a symbol timing based on the TDM pilot symbols;
means for measuring a channel delay spread after the symbol timing has been determined;
means for determining a maximum expected channel delay spread based upon the measured channel delay spread; and
means for selecting a length of a detection window to be used in future to detect the TDM pilot symbols based upon the determined maximum expected channel delay spread.

18. The wireless communication device of claim 17, wherein means for selecting a length of a detection window comprises means for selecting a detection window of an arbitrary length that is equal to or greater than the expected delay spread.

19. The wireless communication device of claim 17, wherein means for selecting a length of a detection window comprises means for selecting a nearest integer larger than the expected delay spread plus a safety margin.

20. The wireless communication device of claim 17, wherein means for selecting a length of a detection window comprises means for selecting a detection window length equal to N/(2*m) plus a safety margin, where m is an integer and N is a length of a channel estimate.

21. The wireless communication device of claim 17, wherein means for selecting a length of a detection window comprises means for selecting among two predefined detection window lengths.

22. The wireless communication device of claim 21, wherein the two predefined detection window lengths are 512 and 1024 chips.

23. The wireless communication device of claim 17, wherein the detection window length is 512 chips, the wireless communication device further comprising means for detecting a first arriving signal path during the TDM pilot symbol comprising:
means for calculating a total received energy E(n) over the detection window for a window positioned at increment 0 and at increment 1024;
means for calculating temporary internal values d(n) for each of n, n+512, n+1024, n+1536 using a formula d(n)=|h(n)|²−|h([n+512]_{mod 2048})|², for 0≦n≦2047, where h(n) is a channel estimate at increment n;
means for using temporary internal values d(n) and the computed received energy E for increments n and n+1024 to compute received energy E for increments n+1 and n+1025;
means for calculating a finite difference value D(n) for a finite difference of order N_{D} as
$${D}_{n} = {\sum }_{i = {N}_{D}}^{2 {N}_{D} - 1} {E}_{n - i} - {\sum }_{i = 0}^{{N}_{D} - 1} {E}_{n - i} ;$$
means for calculating a score value V(n) based on E(n) and D(n);
means for determining when the score value V(n) is maximized; and
means for determining a location of the first arriving signal path during the TDM pilot symbol using an increment n corresponding to the maximized score V(n).

24. The wireless communication device of claim 23, wherein means for calculating the total received energy E at increment n comprises means for the total received energy E using a formula:
$$E ( 0 ) = {\sum }_{n = 0}^{511} {\vert h ( n ) \vert}^{2} ; E ( 1024 ) = {\sum }_{n = 1024}^{1535} {\vert h ( n ) \vert}^{2} . ,$$
where h(n) is a channel estimate at increment n.

25. A processor-readable storage medium having stored thereon processor-executable instructions configured to cause a processor to perform operations comprising:
receiving Time-Domain Multiplexed (TDM) pilot symbols; and
determining a symbol timing based on the TDM pilot symbols;
measuring a channel delay spread after the symbol timing has been determined;
determining a maximum expected channel delay spread based upon the measured channel delay spread; and
selecting a length of a detection window to be used in future to detect the TDM pilot symbols based upon the determined maximum expected channel delay spread.

26. The processor-readable storage medium of claim 25, wherein the stored processor-executable instructions are configured such that selecting a length of a detection window comprises selecting a detection window of an arbitrary length that is equal to or greater than the expected delay spread.

27. The processor-readable storage medium of claim 25, wherein the stored processor-executable instructions are configured such that selecting a length of a detection window comprises selecting a nearest integer larger than the expected delay spread plus a safety margin.

28. The processor-readable storage medium of claim 25, wherein the stored processor-executable instructions are configured such that selecting a length of a detection window comprises selecting a detection window length equal to N/(2*m) plus a safety margin, where m is an integer and N is a length of a channel estimate.

29. The processor-readable storage medium of claim 25, wherein the stored processor-executable instructions are configured such that selecting a length of a detection window comprises selecting among two predefined detection window lengths.

30. The processor-readable storage medium of claim 29, wherein the two predefined detection window lengths are 512 and 1024 chips.

31. The processor-readable storage medium of claim 25, wherein the detection window length is 512 chips, and wherein the stored processor-executable instructions are configured cause a processor to perform operations further comprising detecting a first arriving signal path during the TDM pilot symbol by performing operations comprising:
calculating a total received energy E(n) over the detection window for a window positioned at increment 0 and at increment 1024;
calculating temporary internal values d(n) for each of n, n+512, n+1024, n+1536 using a formula d(n)=|h(n)|²−|([n+512]_{mod 2048})|², for 0≦n≦2047, where h(n) is a channel estimate at increment n;
using temporary internal values d(n) and the computed received energy E for increments n and n+1024 to compute received energy E for increments n+1 and n+1025;
calculating a finite difference value D(n) for a finite difference of order N_{D} as
$${D}_{n} = {\sum }_{i = {N}_{D}}^{2 {N}_{D} - 1} {E}_{n - i} - {\sum }_{i = 0}^{{N}_{D} - 1} {E}_{n - i} ;$$
calculating a score value V(n) based on E(n) and D(n);
determining when the score value V(n) is maximized; and
determining a location of the first arriving signal path during the TDM pilot symbol using an increment n corresponding to the maximized score V(n).

32. The processor-readable storage medium of claim 31, wherein the stored processor-executable instructions are configured such that the total received energy E at increment n is calculated using a formula:
$$E ( 0 ) = {\sum }_{n = 0}^{511} {\vert h ( n ) \vert}^{2} ; E ( 1024 ) = {\sum }_{n = 1024}^{1535} {\vert h ( n ) \vert}^{2} . ,$$
where h(n) is a channel estimate at increment n.

33. A wireless signal processing circuit suitable for use in a wireless communication device, comprising:
a wireless receiver circuit configured to receive an orthogonal frequency domain multiplex signal including Time-Domain Multiplexed (TDM) pilot symbols;
a timing acquisition circuit configured to determine a symbol timing based on the TDM pilot symbols;
a channel delay spread measuring circuit configured to measure a channel delay spread after the symbol timing has been determined and determine a maximum expected channel delay spread based upon the measured channel delay spread; and
a logic circuit configured to select a length of a detection window to be used in future to detect the TDM pilot symbols based upon the determined maximum expected channel delay spread.

34. The wireless signal processing circuit of claim 33, wherein the logic circuit is configured to select a detection window of an arbitrary length that is equal to or greater than the expected delay spread.

35. The wireless signal processing circuit of claim 33, wherein the logic circuit is configured to select a nearest integer larger than the expected delay spread plus a safety margin.

36. The wireless signal processing circuit of claim 33, wherein the logic circuit is configured to select a detection window length equal to N/(2*m) plus a safety margin, where m is an integer and N is a length of a channel estimate.

37. The wireless signal processing circuit of claim 33, wherein the logic circuit is configured to select among two predefined detection window lengths.

38. The wireless signal processing circuit of claim 37, wherein the two predefined detection window lengths are 512 and 1024 chips.

39. The wireless signal processing circuit of claim 33, wherein the detection window length is 512 chips, and wherein the timing acquisition circuit is configured:
calculate a total received energy E(n) over the detection window for a window positioned at increment 0 and at increment 1024;
calculate temporary internal values d(n) for each of n, n+512, n+1024, n+1536 using a formula d(n)=|h(n)|²−|h([n+512]_{mod 2048})|², for 0≦n≦2047, where h(n) is a channel estimate at increment n;
use temporary internal values d(n) and the computed received energy E for increments n and n+1024 to compute received energy E for increments n+1 and n+1025;
calculate a finite difference value D(n) for a finite difference of order N_{D} as
$${D}_{n} = {\sum }_{i = {N}_{D}}^{2 {N}_{D} - 1} {E}_{n - i} - {\sum }_{i = 0}^{{N}_{D} - 1} {E}_{n - i} ;$$
calculate a score value V(n) based on E(n) and D(n);
calculate when the score value V(n) is maximized; and
determine a location of the first arriving signal path during the TDM pilot symbol using an increment n corresponding to the maximized score V(n).

40. The wireless signal processing circuit of claim 39, wherein the timing acquisition circuit is further configured to calculate the total received energy E at increment n is calculated using a formula:
$$E ( 0 ) = {\sum }_{n = 0}^{511} {\vert h ( n ) \vert}^{2} ; E ( 1024 ) = {\sum }_{n = 1024}^{1535} {\vert h ( n ) \vert}^{2} . ,$$
where h(n) is a channel estimate at increment n.

41. A wireless signal processing circuit suitable for use in a wireless communication device, comprising:
means for receiving Time-Domain Multiplexed (TDM) pilot symbols; and
means for determining a symbol timing based on the TDM pilot symbols;
means for measuring a channel delay spread after the symbol timing has been determined;
means for determining a maximum expected channel delay spread based upon the measured channel delay spread; and
means for selecting a length of a detection window to be used in future to detect the TDM pilot symbols based upon the determined maximum expected channel delay spread.

42. The wireless signal processing circuit of claim 41, wherein means for selecting a length of a detection window comprises means for selecting a detection window of an arbitrary length that is equal to or greater than the expected delay spread.

43. The wireless signal processing circuit of claim 41, wherein means for selecting a length of a detection window comprises means for selecting a nearest integer larger than the expected delay spread plus a safety margin.

44. The wireless signal processing circuit of claim 41, wherein means for selecting a length of a detection window comprises means for selecting a detection window length equal to N/(2*m) plus a safety margin, where m is an integer and N is a length of a channel estimate.

45. The wireless signal processing circuit of claim 41, wherein means for selecting a length of a detection window comprises means for selecting among two predefined detection window lengths.

46. The wireless signal processing circuit of claim 45, wherein the two predefined detection window lengths are 512 and 1024 chips.

47. The wireless signal processing circuit of claim 41, wherein the detection window length is 512 chips, the wireless communication device further comprising means for detecting a first arriving signal path during the TDM pilot symbol comprising:
means for calculating a total received energy E(n) over the detection window for a window positioned at increment 0 and at increment 1024;
means for calculating temporary internal values d(n) for each of n, n+512, n+1024, n+1536 using a formula d(n)=|h(n)|²−|h([n+512]_{mod 2048})|², for 0≦n≦2047, where h(n) is a channel estimate at increment n;
means for using temporary internal values d(n) and the computed received energy E for increments n and n+1024 to compute received energy E for increments n+1 and n+1025;
means for calculating a finite difference value D(n) for a finite difference of order N_{D} as
$${D}_{n} = {\sum }_{i = {N}_{D}}^{2 {N}_{D} - 1} {E}_{n - i} - {\sum }_{i = 0}^{{N}_{D} - 1} {E}_{n - i} ;$$
means for calculating a score value V(n) based on E(n) and D(n);
means for determining when the score value V(n) is maximized; and
means for determining a location of the first arriving signal path during the TDM pilot symbol using an increment n corresponding to the maximized score V(n).

48. The wireless signal processing circuit of claim 47, wherein means for calculating the total received energy E at increment n comprises means for the total received energy E using a formula:
$$E ( 0 ) = {{\sum }_{n = 0}}^{511} {\vert h ( n ) \vert}^{2} ; E ( 1024 ) = {\sum }_{n = 1024}^{1535} {\vert h ( n ) \vert}^{2} . ,$$
where h(n) is a channel estimate at increment n.
